(19) United States
(12) Patent Application Publication
(10) Pub. No.: US 2021/0288321 A1
(43) Pub. Date: Sep. 16, 2021

(54) LITHIUM MULTIPLE METAL OXIDE-BASED CATHODE ACTIVE MATERIALS FOR LITHIUM SECONDARY BATTERIES

(71) Applicant: Global Graphene Group, Inc., Dayton, OH (US)

(72) Inventors: Mingrui Liu, Dayton, OH (US); Hao-Hsun Chang, Centerville, OH (US); Bor Z. Jang, Centerville, OH (US)

(21) Appl. No.: 16/818,036

(22) Filed: Mar. 13, 2020

(51) Int. Cl. H01M 4/525; H01M 10/0525; C01G 53/00

(52) U.S. Cl. CPC H01M 4/525; H01M 2004/028; C01G 53/42; H01M 10/0525

(57) ABSTRACT

Provided is a cathode active material for a lithium-ion battery, wherein the cathode active material is selected from the group of lithium nickel cobalt metal oxides having a general formula LiₓNi_{y}Co_{z}M_{w}O₂, where M is selected from the group consisting of beryllium (Be), calcium (Ca), and combinations thereof with aluminum (Al), titanium (Ti), tungsten (W), chromium (Cr), molybdenum (Mo), magnesium (Mg), tantalum (Ta), and silicon (Si), and x ranges from 0 to 1.2, the sum of y+z+w ranges from 0.8 to 1.2, w range from 0 to 0.5, y and z are both greater than zero, and the ratio z/y ranges from 0 to 0.5. Preferably, M is selected from metal elements comprising combined Be and Mg, combined Ca and Mg, combined Ca and Be, or combined Be, Mg, and Ca.

### FIELD

The present disclosure relates generally to the field of lithium-ion batteries and, in particular, to lithium multiple transition metal oxide-based cathode active materials for lithium-ion or lithium metal batteries.

### BACKGROUND

Next generation lithium-ion batteries (LIBs) are a prime candidate for energy storage devices within aircraft, electric vehicles (EVs), drones, renewable energy storage, and smart grid applications. The emerging EV and renewable energy industries demand the availability of rechargeable batteries with a significantly higher energy and power density than what current LIB technology can provide. This requirement has triggered considerable research efforts on the development of both anode and cathode materials with a higher specific capacity, excellent rate capability, and good cycle stability for LIBs.

The most commonly used anode active materials for lithium-ion batteries are natural graphite and synthetic graphite (or artificial graphite) that can be intercalated with lithium and the resulting graphite intercalation compound may be expressed as LiₓC₆, where x is typically less than 1. The maximum amount of lithium that can be reversibly intercalated into the interstices between graphene planes of a perfect graphite crystal corresponds to x=1, defining a theoretical specific capacity of 372 mAh/g. Other inorganic materials that have been evaluated for potential anode applications include metal oxides, metal nitrides, metal sulfides, and the like, and a range of metals, metal alloys, and intermetallic compounds that can accommodate lithium atoms/ions or react with lithium. Among these materials, lithium alloys having a composition formula of LiₐA (A is a metal or semiconductor element, such as Al and Si, and “a” satisfies 0<a≤5) are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g).

Commonly used cathode active materials for lithium-ion batteries include lithium nickel manganese cobalt oxide (“NMC” or “NCM”, LiNiₓMn_{y}Co_{z}O₂), lithium nickel cobalt aluminum oxide (“NCA”, LiNiCoAlO₂), lithium manganese oxide (“LMO”, LiMn₂O₄), lithium iron phosphate (“LFP”, LiFePO₄), and lithium cobalt oxide (LiCoO₂, “LCO”), etc. The practical or currently achievable specific capacities of these commonly used cathode active materials are typically in the range from 140-200 mAh/g (more typically 150-180 mAh/g), leading to low specific energy (gravimetric energy density, Wh/kg) and low energy density (volumetric energy density, Wh/L).

An urgent need exists to have a high-capacity cathode active material to pair up with a high-capacity anode active material, such as Si, SiO, Sn, and SnO₂, for the purpose of achieving high specific energies and high energy densities.

### SUMMARY

It may be noted that the word “electrode” herein refers to either an anode (negative electrode) or a cathode (positive electrode) of a battery. These definitions are also commonly accepted in the art of batteries or electrochemistry.

The present disclosure provides a cathode active material selected from the group of lithium nickel cobalt metal oxides having a general formula LiₓNi_{y}Co_{z}M_{w}O₂, where M is selected from the group consisting of aluminum (Al), titanium (Ti), tungsten (W), chromium (Cr), molybdenum (Mo), magnesium (Mg), beryllium (Be), calcium (Ca), tantalum (Ta), silicon (Si), and combinations thereof and x ranges from 0 to 1.2 (can be varied within this range by electrochemical insertion and extraction), the sum of y+z+w ranges from 0.8 to 1.2, w is from 0.25 to 0.5, y and z are both greater than zero, and the ratio z/y ranges from 0 to 0.5. It may be noted that M can be a combination of multiple elements. A particularly desired class of cathode materials contains M that is selected from Be, Mg, Ca and their various combinations and their combinations with Mn (manganese) and/or Al (aluminum). It may be noted that the lithium-ion cell has a higher specific capacity when w is from 0 to 0.25 and has a more stable cycling behavior if w is from 0.25 to 0.5.

Also provided is a cathode active material for a lithium-ion battery, wherein the cathode active material is selected from the group of lithium nickel cobalt metal oxides having a general formula LiₓNi_{y}Co_{z}M_{w}O₂, where M is selected from the group consisting of beryllium (Be), calcium (Ca), and combinations thereof with aluminum (Al), titanium (Ti), tungsten (W), chromium (Cr), molybdenum (Mo), magnesium (Mg), tantalum (Ta), and silicon (Si), and x ranges from 0 to 1.2, the sum of y+z+w ranges from 0.8 to 1.2, w is from 0 to 0.5, y and z are both greater than zero, and the ratio z/y ranges from 0 to 0.5.

In some embodiments of the general formula of LiₓNi_{y}Co_{z}M_{w}O₂, M comprises multiple elements selected from selected from the group consisting of aluminum (Al), titanium (Ti), tungsten (W), chromium (Cr), molybdenum (Mo), magnesium (Mg), beryllium (Be), calcium (Ca), tantalum (Ta), silicon (Si), and combinations thereof. In a non-limiting example, M contains BeₐMg_{b}Ca_{c}, where a+b+c=w. M may be a in the form of M⁰ₐ, M⁰ₐM¹_{b}, or M⁰ₐM_{b}M²_{c}, where M⁰ M¹ and M² are elements selected from the group consisting of aluminum (Al), titanium (Ti), tungsten (W), chromium (Cr), molybdenum (Mo), magnesium (Mg), beryllium (Be), calcium (Ca), tantalum (Ta), and silicon (Si), wherein a+b+c=w.

In certain embodiments, M comprises elements selected from combined Be and Mg, combined Ca and Mg, combined Ca and Be, or combined Be, Mg, and Ca. Preferably, M contains BeₐMg_{b}Ca_{c}, where a+b+c=w. Most preferably, a, b, and c are all non-zero figures.

The cathode active material may be in a form of fine particles having a dimension from 10 nm to 20 μm, more preferably from 50 nm to 10 μm.

The disclosure also provides a powder mass of multiple particles of the cathode active material as defined above. Also provided is a lithium battery cathode electrode containing a mass of this type and optional conductive filler (typically 0-15% by weight) and optional binder (typically 0-15% by weight). In some embodiments, the disclosure provides a lithium battery containing such a cathode electrode. In some embodiments, the provided lithium-ion cell or lithium metal secondary cell comprises an anode, a cathode as described above, and an electrolyte in ionic contact with the anode and the cathode.

The anode in the lithium-ion cell or lithium metal secondary cell may comprise an anode active material selected from the group consisting of: (a) silicon (Si), germanium (Ge), phosphorus (P), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, P, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium niobium oxide, lithium titanium-niobium oxide, lithium aluminate, lithium-containing titanium oxide, lithium transition metal oxide, ZnCo₂O₄; (f) particles of graphite; (g) lithium metal or lithium alloy containing greater than 80% by weight of lithium; and combinations thereof.

The disclosure further provides a method of producing the cathode active material as described above, wherein the method comprises a procedure selected from co-precipitation, spray-drying, solid-state reaction, or combustion.

### BRIEF DESCRIPTION OF THE DRAWINGS

FIG. 1 X-ray diffraction curves of certain cathode active materials herein produced.

FIG. 2 SEM image of certain cathode active material particles.

FIG. 3 Specific capacities of LiNi_{y}Co_{z}Mg_{0.5w}Ca_{0.5w}O₂ tested at different C rates (1C rate=discharge or charge in 1 hour, nC rate=discharge or charge in 1/n hours).

FIG. 4 Charge-discharge curves of a LiNi_{y}Co_{z}Mg_{w}O₂ material.

FIG. 5 Discharge capacities of a LiNi_{y}Co_{z}Mg_{w}O₂ material and those of a conventional NCM-622 cathode material plotted as a function of charge/discharge cycle number.

### DETAILED DESCRIPTION OF PREFERRED EMBODIMENTS

The present disclosure provides a cathode active material for use in a lithium battery. In certain embodiments, the cathode active material is selected from the group of lithium cobalt metal oxides having a general formula LiₓNi_{y}Co_{z}M_{w}O₂, where M is selected from the group consisting of aluminum (Al), titanium (Ti), tungsten (W), chromium (Cr), molybdenum (Mo), magnesium (Mg), beryllium (Be), calcium (Ca), tantalum (Ta), silicon (Si), and combinations thereof and x ranges from 0 to 1.2 (can be varied within this range by electrochemical insertion and extraction, in some embodiments x has been 1, 1.02, and 1.1), the sum of y+z+w ranges from 0.8 to 1.2, w ranges from 0 to 0.5 (w from 0.25 to 0.5 in certain embodiments), y and z are both greater than zero, and the ratio z/y ranges from 0 to 0.5 (w ranges from 0 to about ⅓ in certain embodiments).

Preferably, the cathode active material is selected from the group of lithium nickel cobalt metal oxides having a general formula LiₓNi_{y}Co_{z}M_{w}O₂, where M is selected from the group consisting of beryllium (Be), calcium (Ca), and combinations thereof with aluminum (Al), titanium (Ti), tungsten (W), chromium (Cr), molybdenum (Mo), magnesium (Mg), tantalum (Ta), and silicon (Si), and x ranges from 0 to 1.2, the sum of y+z+w ranges from 0.8 to 1.2, w ranges from 0 to 0.5, y and z are both greater than zero, and the ratio z/y ranges from 0 to 0.5.

In some embodiments of the general formula of LiₓNi_{y}Co_{z}M_{w}O₂, M comprises multiple elements selected from selected from the group consisting of aluminum (Al), titanium (Ti), tungsten (W), chromium (Cr), molybdenum (Mo), magnesium (Mg), beryllium (Be), calcium (Ca), tantalum (Ta), silicon (Si), and combinations thereof. M may be a in the form of M⁰ₐ, M⁰ₐM_{b}, or M⁰ₐM_{b}M²_{c}, where M⁰ M¹ and M² are elements selected from the group consisting of aluminum (Al), titanium (Ti), tungsten (W), chromium (Cr), molybdenum (Mo), magnesium (Mg), beryllium (Be), calcium (Ca), tantalum (Ta), and silicon (Si), wherein a+b+c=w. In some embodiments M_{w} comprises multiple elements and w is equal to the sum of M elements in the LiₓNi_{y}Co_{z}M_{w}O₂.

Further preferably, M comprises multiple elements selected from combined Be and Mg, combined Ca and Mg, combined Ca and Be, or combined Be, Mg, and Ca. In some embodiments of instant disclosure, M contains BeₐMg_{b}Ca_{c}, where a+b+c=w and in some embodiments, a, b, and c are all non-zero figures.

This class of cathode active material is generally related to lithium metal oxides containing nickel, cobalt, and a third element, typically a metal (M). M may represent a combination of 2, 3, or more elements. It may be noted that if M is not a metal with a valence state of +3 (e.g., magnesium, beryllium, and calcium with a valence state of +2, or silicon with a valence of +4), the sum of y+z+w may deviate somewhat from 1. For metals of valence +2, such as magnesium, beryllium, and calcium, the sum will be slightly larger than 1 in order to balance the −4 charge on the two oxygen atoms. For elements of valence +4, such as silicon, the sum will be slightly less than 1.

In general, these compounds have the layered structure of α-NaCrO₂ crystals, wherein lithium ions can move through the lattice rapidly, along the lattice planes. This structure is also found in LiCoO₂ and LiNiO₂, which are a significantly different structure than the LiMn₂O₄ spinnel structure. Further, these compounds have a significantly greater variation in potential with state of charge (i.e., sloping discharge profile) than the corresponding simple oxides, particularly LiCoO₂. The element nickel appears to impart a very high capacity to these compounds. Depending upon the relative amounts of cobalt and other metals in the compound, any given compound may have a reversible capacity typically in the range from 180 to 215 mAh/g. For comparison, LiCoO₂ has an observed capacity of about 139-148 mAh/g and LiMn₂O₄ has an observed capacity of about 120-148 mAh/g. Cobalt appears to be capable of improving the stability of the compound by holding other transition metal atoms, especially nickel, in place within the lattice.

The presence of the third element or elements (M) in the lattice is believed to be able to improve cell safety on overcharge. The lithium metal oxides, particularly lithium nickel oxide, may undergo exothermic decomposition with the release of oxygen on overcharge. This and other detrimental overcharge reactions may be reduced if the lithium metal oxide compound becomes less conductive in a highly delithiated state.

A particularly desired class of cathode materials contains M being selected from Be, Mg, Ca and their various combinations and their combinations with Mn (manganese) and/or Al (aluminum). The present of these elements appear to impact cycling stability to the lithium-ion cells containing these cathode active materials.

Several methods have been proposed to produce lithium mixed transition metal oxides: the co-precipitation method, spray drying method, high temperature solid state reaction, and combustion method.

Co-precipitation method is a useful preparation process for the industrial production of lithium mixed transition metal oxide-based cathode active materials. This method can be used to synthesize precursor with excellent spherical morphology and good element mixing at an atomic level. The precipitation conditions such as co-precipitation temperature, pH value of solution, and stirring intensity play a critical role in the performance of precursor.

For example, for hydroxide co-precipitation conditions of Ni_{0.6}Co_{0.2}Mn_{0.2}(OH)₂, the particles became small with an increase in the pH value, while the particles of precursor became quasi-spherical with increasing chelating agent concentration and stirring speed. When the Co content in Ni_{0.6}MnCo(OH)₂ increased, the tap-density and the initial discharge capacity of NCM622 increased, but their cycling stability decreased owing to the acceleration of grain growth. The NCM622 cathode materials with the concentration gradient of Mn and Ni elements were synthesized using hydroxide co-precipitation method.

Spray drying is another useful method to synthesize the cathode materials with good atomic level mixing of elements. The resulting cathode active material particles are smaller and quasi-spherical. Furthermore, the spray drying method can achieve continuous production with an automatic control and can have high production efficiency. However, the large-scale production of spray drying method can be challenging due to the complicated process and the required high precision of the equipment.

Compounds having the formula LiₓNi_{y}Co_{z}M_{w}O₂ may be prepared by high temperature solid state reactions in the following. The process typically begins with mixing a desired lithium-containing compound, a specified element M-containing compound (e.g., Al, Mg, Be, Ca, etc.), a cobalt-containing compound, and a nickel-containing compound. The various components are homogeneously mixed and then thermally reacted at a temperature of between about 500° C. and 1300° C. For many compounds, the preferred reaction temperature is between about 600° C. and 1000° C., and most preferably between about 750° C. and 850° C. Further, the reaction is preferably conducted in an atmosphere of flowing air or, more preferably, flowing oxygen.

The desired lithium-containing compound may be any one or more of lithium nitrate (LiNO₃), lithium hydroxide (LiOH), lithium acetate (LiO₂CCH₃), and lithium carbonate (Li₂CO₃), for example. The cobalt-containing compound may be any one or more of cobalt metal, cobalt oxide (Co₃O₄ or CoO), cobalt carbonate (CoCO₃), cobalt nitrate (Co(NO₃)₂), cobalt hydroxide (Co(OH)₂), and cobalt acetate (Co(O₂CCH₃)₂), for example. The nickel containing compound may be any one or more of nickel metal, nickel oxide (NiO), nickel carbonate (NiCO₃), nickel acetate (Ni(O₂CCH₃)₂), and nickel hydroxide (Ni(OH)₂), for example. If the M-containing compound is to provide aluminum, this compound may be selected from any one or more of aluminum hydroxide (Al(OH)₃), aluminum oxide (A₂O₃), aluminum carbonate (Al₂(CO₃)₃), and aluminum metal, for example. Other M-containing materials may be employed to provide non-aluminum containing materials such as magnesium oxide (MgO), beryllium oxide (BeO), calcium oxide (CaO), metal calcium (Ca), molybdenum oxide (MoO₃), titanium oxide (TiO₂), tungsten oxide (WO₂), chromium metal, chromium oxide (CrO₃ or Cr₂O₃), tantalum oxide (Ta₂O₄ or Ta₂O₅), etc.

Alternatively, one may simply combine the simple lithium oxides of the metals and heat-treat the mixture to form the final compound. This process entails combining lithium cobalt oxide, lithium nickel oxide, and a lithium metal oxide of the formula LiMO₂, where M is preferably magnesium, aluminum, chromium, or titanium. For instance, in order to obtain LiNi_{0.6}Co₀₁₅Al_{0.25}O₂, metal oxides, including LiNiO₂, LiCoO₂, and LiAlO₂, could be mixed in a 60:15:25 molar ratio. The resulting mixture is then reacted at high temperatures as described above.

In the combustion synthesis, the organic metal salts are usually first mixed with nitric acid/urea, and then the resulting mixture is heated directly to the ignition temperature. Finally the cathode materials are synthesized by the exothermic heat of the material in the chemical reaction. The combustion method is known for its main advantages of simple equipment, low cost, and being without external energy. But it is restricted because of the shortcomings of large particle size and poor controllability.

In some embodiments, the cathode active material particles include powder, flakes, beads, pellets, spheres, wires, fibers, filaments, discs, ribbons, or rods, having a diameter or thickness from 10 nm to 20 μm. Preferably, the diameter or thickness is from 1 μm to 100 μm.

Multiple particles of the presently disclosed cathode active material may be made into powder mass. This powder mass may be used as a cathode active material for a lithium-ion cell or lithium metal secondary cell.

The anode in the lithium-ion cell or lithium metal secondary cell may comprise an anode active material selected from the group consisting of: (a) silicon (Si), germanium (Ge), phosphorus (P), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, P, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium niobium oxide, lithium titanium-niobium oxide, lithium aluminate, lithium-containing titanium oxide, lithium transition metal oxide, ZnCo₂O₄; (f) particles of graphite; (g) lithium metal or lithium alloy containing greater than 80% by weight of lithium; and combinations thereof.

A wide range of electrolytes can be incorporated into the lithium cells: liquid electrolyte, polymer gel electrolyte, polymer electrolyte, solid state electrolyte, composite electrolyte, etc. Most preferred are non-aqueous and polymer gel electrolytes although other types can be used. The non-aqueous electrolyte to be employed herein may be produced by dissolving an electrolytic salt in a non-aqueous solvent. Any known non-aqueous solvent which has been employed as a solvent for a lithium secondary battery can be employed. A non-aqueous solvent mainly consisting of a mixed solvent comprising ethylene carbonate (EC) and at least one kind of non-aqueous solvent whose melting point is lower than that of aforementioned ethylene carbonate (hereinafter referred to as a second solvent) may be preferably employed. This non-aqueous solvent is advantageous in that it is (a) stable against a negative electrode containing a carbonaceous material well developed in graphite structure; (b) effective in suppressing the reductive or oxidative decomposition of electrolyte; and (c) high in conductivity. A non-aqueous electrolyte solely composed of ethylene carbonate (EC) is advantageous in that it is relatively stable against decomposition through a reduction by a graphitized carbonaceous material. However, the melting point of EC is relatively high, 39 to 40° C., and the viscosity thereof is relatively high, so that the conductivity thereof is low, thus making EC alone unsuited for use as a secondary battery electrolyte to be operated at room temperature or lower. The second solvent to be used in a mixture with EC functions to make the viscosity of the solvent mixture lower than that of EC alone, thereby promoting the ion conductivity of the mixed solvent. Furthermore, when the second solvent having a donor number of 18 or less (the donor number of ethylene carbonate is 16.4) is employed, the aforementioned ethylene carbonate can be easily and selectively solvated with lithium ion, so that the reduction reaction of the second solvent with the carbonaceous material well developed in graphitization is assumed to be suppressed. Further, when the donor number of the second solvent is controlled to not more than 18, the oxidative decomposition potential to the lithium electrode can be easily increased to 4 V or more, so that it is possible to manufacture a lithium secondary battery of high voltage.

Preferable second solvents are dimethyl carbonate (DMC), methylethyl carbonate (MEC), diethyl carbonate (DEC), ethyl propionate, methyl propionate, propylene carbonate (PC), .gamma.-butyrolactone (.gamma.-BL), acetonitrile (AN), ethyl acetate (EA), propyl formate (PF), methyl formate (MF), toluene, xylene and methyl acetate (MA). These second solvents may be employed singly or in a combination of two or more. More desirably, this second solvent should be selected from those having a donor number of 16.5 or less. The viscosity of this second solvent should preferably be 28 cps or less at 25° C.

The mixing ratio of the aforementioned ethylene carbonate in the mixed solvent should preferably be 10 to 80% by volume. If the mixing ratio of the ethylene carbonate falls outside this range, the conductivity of the solvent may be lowered or the solvent tends to be more easily decomposed, thereby deteriorating the charge/discharge efficiency. More preferable mixing ratio of the ethylene carbonate is 20 to 75% by volume. When the mixing ratio of ethylene carbonate in a non-aqueous solvent is increased to 20% by volume or more, the solvating effect of ethylene carbonate to lithium ions will be facilitated and the solvent decomposition-inhibiting effect thereof can be improved.

Examples of preferred mixed solvent are a composition comprising EC and MEC; comprising EC, PC and MEC; comprising EC, MEC and DEC; comprising EC, MEC and DMC; and comprising EC, MEC, PC and DEC; with the volume ratio of MEC being controlled within the range from 30 to 80%. By selecting the volume ratio of MEC from the range of 30 to 80%, more preferably 40 to 70%, the conductivity of the solvent can be improved. With the purpose of suppressing the decomposition reaction of the solvent, an electrolyte having carbon dioxide dissolved therein may be employed, thereby effectively improving both the capacity and cycle life of the battery.

The electrolytic salts to be incorporated into a non-aqueous electrolyte may be selected from a lithium salt such as lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃) and bis-trifluoromethyl sulfonylimide lithium [LiN(CF₃SO₂)₂]. Among them, LiPF₆, LiBF₄ and LiN(CF₃SO₂)₂ are preferred. The content of aforementioned electrolytic salts in the non-aqueous solvent is preferably from 0.5 to 2.0 mol/l.

The following examples serve to provide the best modes of practice for the present disclosure and should not be construed as limiting the scope of the disclosure:

### Example 1: Production of LiNi_{0.75} Al_{0.25} O₂ and LiNi_{0.6}Co_{0.05} Mg_{0.3} Al_{0.05}O₂ Particles

Particles of LiNi_{0.75} Al_{0.25} O₂ (as a prior art baseline material) was prepared by combining 1.05 moles of vacuum-dried LiNO₃ powder (100° C., 4 hours) with 1.0 mole of a mixture of NiO and Al(OH)₃ reactants at a molar ratio of 75/25 of Ni/Al. A good mix of the reactants was obtained by continuously rotating a plastic container containing the chemicals and some stainless steel balls on a machine at about 60 rpm for 1 hour. The resulting mixture was compressed into pellets in a press at 4500 lb/in². The pellets then were placed into an alumina crucible, and heated in a retort furnace (a) first under a flowing argon atmosphere at 400° C. for 4 hours (to safely remove NO₂ and other gaseous products), followed by (b) heating under a flowing oxygen atmosphere at 750° C. for 16 hours. The reacted pellets were then crushed, ground, and sieved to less than 63 μm, following by a washing step with deionized water and vacuum drying the powder (to remove any remaining water soluble reactants or unwanted products). Next, the powder was compressed into a pellet at 4500 lb/in², and heated a second time under flowing oxygen at 750° C. for 16 hours. The product was crushed, ground, and sieved to less than 32 μm. The regrinding and reheating process was performed to insure complete reaction of the reactants to form the product.

In a similar manner, particles of LiNi_{0.6}Co_{0.05}Mg_{0.3}Al_{0.05}O₂ were prepared by firstly mixing powders of LiNO₃, NiCO₃, CoCO₃, Mg(OH)₂, and Al(OH)₃ at a desired stoichiometric ratio to form a reaction mixture. The reaction mixture was then heated at 750° C. under an oxygen stream for 24 hours. The composition of the resulting mixed metal oxides was confirmed by using X-ray diffraction.

### Example 2: Production of LiNi_{0.8}Co_{0.05} Be_{0.05} Ca_{0.10}O₂ Particles

The LiNi_{0.8}Co_{0.05} Be_{0.05} Ca_{0.10}O₂ particles were synthesized by following a procedure similar to that in Example 1, with the exception that Mg(OH)₂ and Al(OH)₃ were replaced by Ca(OH)₂ and Be(OH)₂.

### Example 3: Production of LiNi_{y}Co_{z}Mg_{w}O₂ and LiNi_{y}Co_{z}Mg_{0.5w}Ca_{0.5w}O₂

The synthesis of the Ni-rich cathode materials LiNi_{y}Co_{z}M_{w}O₂ (M=Mg) involved co-precipitation and calcination. In an experiment, for instance, two solutions were firstly prepared: (i) solution A, an aqueous mixture of NiSO₄.6H₂O, CoSO₄.7H₂O, and MgSO₄ in designed ratios; and (ii) solution B, an aqueous mixture of NaOH (0.5˜2.0 M) and NH₄OH (0.5˜1.3 M).

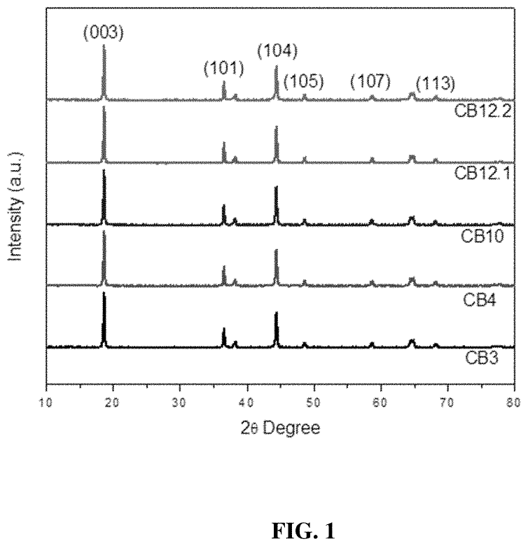

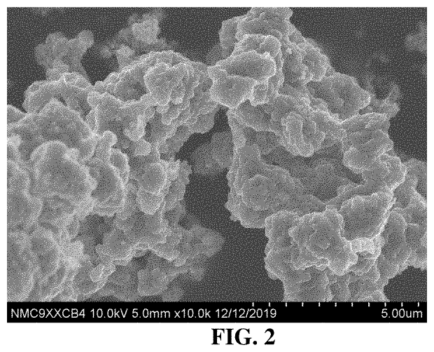

Substantially equivalent amounts of solution A and solution B were simultaneously pumped into the reactor. The pH of the reactant solution was maintained at a value from 10 to 12. Nitrogen gas was introduced to avoid the oxidation of precursors. The required co-precipitation reaction time was approximately 5-24 hours. Then, the formed greenish NiₐCo_{b}Mg_{c}(OH)₂ precursor was filtered and washed repeatedly with deionized water until the pH of the filtrate was close to 7.0. The filtered powders were dried at 120° C. for 10 h. For the subsequent calcination process, the NiₐCo_{b}Mg_{c}(OH)₂ precursor was thoroughly mixed with LiOH.H₂O (molar ratio 1:1.02˜1.10) using mortar and pre-calcinated at 500˜550° C. for 5-10 h, followed by heating at 650˜800° C. for 12-24 h with flowing oxygen gas. X-ray diffraction curves of several samples herein produced are shown in FIG. 1. Shown in FIG. 2 is an SEM image of the cathode active material particles herein produced.

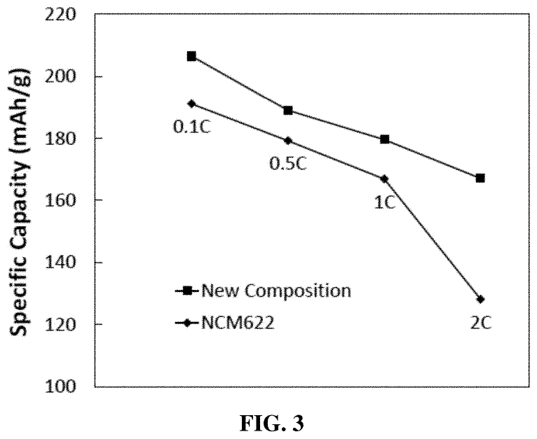

A similar process was followed to produce the lithium mixed transition metal oxides with M=combined Mg and Ca by replacing half of the MgSO₄ with CaSO₄. FIG. 3 shows the specific capacities of LiNi_{y}Co_{z}Mg_{0.5w}Ca_{0.5w}O₂ tested at different C rates. They perform much better as compared with the current industry standard NCM622.

### Example 4: Preparation and Electrochemical Testing of Various Battery Cells

For most of the cathode active materials investigated, we prepared lithium-ion cells or lithium metal cells using the conventional slurry coating method. A typical anode composition includes 85 wt. % active material (e.g., graphene-encapsulated cathode particles), 7 wt. % acetylene black (Super-P), and 8 wt. % polyvinylidene fluoride binder (PVDF, 5 wt. % solid content) dissolved in N-methyl-2-pyrrolidinoe (NMP). After coating the slurries on Al foil, the electrodes were dried at 120° C. in vacuum for 2 h to remove the solvent. An anode layer (e.g. Li metal for a half cell test), a porous separator layer (e.g. Celgard 2400 membrane), and a cathode layer are then laminated together and housed in a plastic-Al envelop. The cell is then injected with 1 M LiPF₆ electrolyte solution dissolved in a mixture of ethylene carbonate (EC) and diethyl carbonate (DEC) (EC-DEC, 1:1 v/v). In some cells, ionic liquids were used as the liquid electrolyte. The cell assemblies were made in an argon-filled glove-box.

The cyclic voltammetry (CV) measurements were carried out using an Arbin electrochemical workstation at a typical scanning rate of 1 mV/s. In addition, the electrochemical performances of various cells were also evaluated by galvanostatic charge/discharge cycling at a current density of from 50 mA/g to 10 A/g.

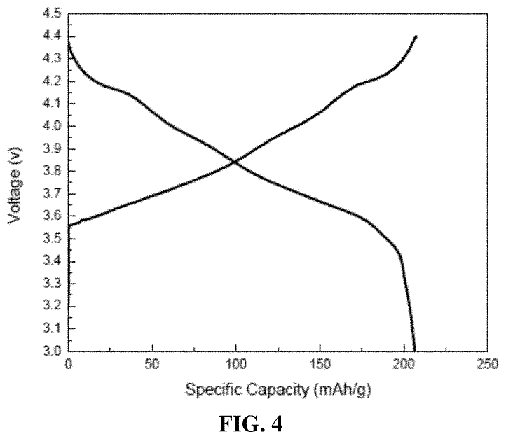

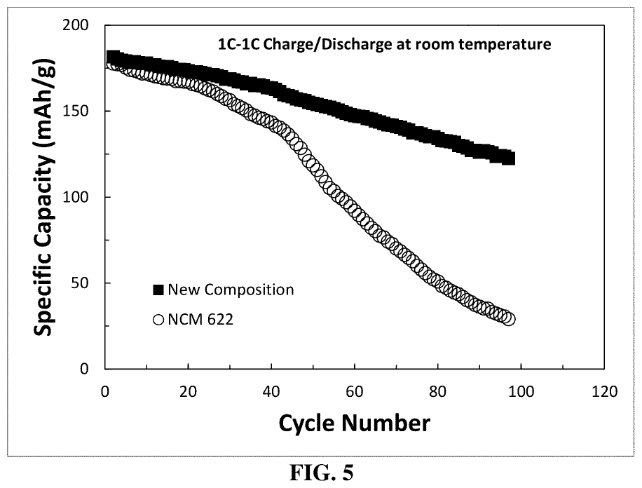

FIG. 4 shows the charge-discharge curves of a LiNi_{y}Co_{z}Mg_{w}O₂ material herein produced, indicating a specific capacity higher than 200 mAh/g. Shown in FIG. 5 are the discharge capacities of a LiNi_{y}Co_{z}Mg_{w}O₂ material and those of a conventional NCM-622 cathode material plotted as a function of charge/discharge cycle number. These data have demonstrated that the presently disclosed cathode active material is superior to the most widely used cathode active materials in terms of cycling stability. We have further observed that the presence of a graphene-based encapsulating shell can significantly improve the rate capability of the cathode active materials. These cathode particulates, when tested under higher charge/discharge rates, exhibit higher specific capacities as compared to the corresponding cathode particles without graphene encapsulation.

1. A cathode active material for a lithium-ion battery, wherein the cathode active material is selected from the group of lithium nickel cobalt metal oxides having a general formula LiₓNi_{y}Co_{z}M_{w}O₂, where M is selected from the group consisting of aluminum (Al), titanium (Ti), tungsten (W), chromium (Cr), molybdenum (Mo), magnesium (Mg), beryllium (Be), calcium (Ca), tantalum (Ta), silicon (Si), and combinations thereof and x ranges from 0 to 1.2, the sum of y+z+w ranges from 0.8 to 1.2, w range from 0 to 0.5, y and z are both greater than zero, and the ratio z/y ranges from 0 to 0.5.

2. A cathode active material for a lithium-ion battery, wherein the cathode active material is selected from the group of lithium nickel cobalt metal oxides having a general formula LiₓNi_{y}Co_{z}M_{w}O₂, where M is selected from the group consisting of beryllium (Be), calcium (Ca), and combinations thereof with aluminum (Al), titanium (Ti), tungsten (W), chromium (Cr), molybdenum (Mo), magnesium (Mg), tantalum (Ta), and silicon (Si), and ranges from 0 to 1.2, the sum of y+z+w ranges from 0.8 to 1.2, w range from 0.25 to 0.5, y and z are both greater than zero, and the ratio z/y ranges from 0 to 0.5.

3. The cathode active material of claim 1, wherein M comprises elements selected from combined Be and Mg, combined Ca and Mg, combined Ca and Be, or combined Be, Mg, and Ca.

4. The cathode active material of claim 2, wherein M comprises elements selected from combined Be and Mg, combined Ca and Mg, combined Ca and Be, or combined Be, Mg, and Ca.

5. The cathode active material of claim 2, wherein said cathode active material is in a form of fine particles having a dimension from 10 nm to 20 μm.

6. The cathode active material of claim 1, wherein said cathode active material is in a form of fine particles having a dimension from 50 nm to 10 μm.

7. A powder mass comprising multiple particles of the cathode active material of claim 1.

8. A cathode comprising the powder mass of claim 7 as a cathode active material for a lithium-ion cell or lithium metal secondary cell.

9. A lithium-ion cell or lithium metal secondary cell comprising an anode, a cathode of claim 8, and an electrolyte in ionic contact with the anode and the cathode.

10. The lithium-ion cell or lithium metal secondary cell of claim 9, wherein said anode comprises an anode active material selected from the group consisting of: (a) silicon (Si), germanium (Ge), phosphorus (P), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, P, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium niobium oxide, lithium titanium-niobium oxide, lithium aluminate, lithium-containing titanium oxide, lithium transition metal oxide, ZnCo₂O₄; (f) particles of graphite; (g) lithium metal or lithium alloy containing greater than 80% by weight of lithium; and combinations thereof.

11. A method of producing the cathode active material of claim 1, said method comprising a procedure selected from co-precipitation, spray-drying, solid-state reaction, or combustion.
